(19) United States
(12) Patent Application Publication
(10) Pub. No.: US 2024/0028725 A1
(43) Pub. Date: Jan. 25, 2024

(54) Data Processing Arrangement and Method for Detecting Ransomware in a File Catalog

(71) Applicant: Huawei Technologies Co., Ltd., Shenzhen (CN)

(72) Inventors: David Segal, Hod Hasharon (IL); Asaf Yeger, Hod Hasharon (IL); Assaf Natanzon, Hod Hasharon (IL); Michael Gutman, Hod Hasharon (IL); Shmoolik Yosub, Hod Hasharon (IL); Shahar Salzman, Hod Hasharon (IL)

(21) Appl. No.: 18/477,124

(22) Filed: Sep. 28, 2023

Related U.S. Application Data
(63) Continuation of application No. PCT/EP2021/058985, filed on Apr. 7, 2021.

(51) Int. Cl. G06F 21/56; G06F 21/55

(52) U.S. Cl. CPC G06F 21/566; G06F 21/554; G06F 2221/034

(57) ABSTRACT

Provided is a data processing arrangement (100, 200, 300, 400) that is coupled to a data memory arrangement (102) and is configured to generate a file catalog including information describing characteristics of data files stored within the data memory arrangement. The file catalog is periodically updated so that it provides a temporal record of the information. The data processing arrangement is configured to determine a behavioral profile (404) indicative of temporal trends or patterns in the information, and to provide a warning indication in an event that the information for a given data file temporally changes in a manner that deviates more than a threshold amount from a model of expected temporal trends or patterns of the given data file.

### CROSS-REFERENCE TO RELATED APPLICATIONS

This application is a continuation of International Application No. PCT/EP2021/058985, filed on Apr. 7, 2021, which is hereby incorporated by reference in their entireties.

### FIELD

The disclosure relates generally to secondary storage systems and intelligent data management; more particularly, the disclosure relates to a data processing arrangement that is coupled to a data memory arrangement and is configured to generate a file catalog for detecting a ransomware attack. Moreover, the disclosure relates to a method for operating a data processing arrangement coupled to a data memory arrangement for generating a file catalog for detecting the ransomware attack in a system.

### BACKGROUND

Secondary storage is non-volatile, long-term storage. The secondary storage is used to keep programs and data for longterm periods of time, for example decades of years. Without the secondary storage, all programs and data may be lost when a computing device is switched off. For the secondary storage, businesses and enterprises typically use a backup to tape, or a backup to disk in a form of network-attached storage (NAS) or storage area network (SAN) devices. Files and objects (for example Simple Storage Service (S3) objects) are typically spread among different physical machines and virtual machines located on different hosts, hosts type (for example Virtual machine software, Hyper-V, and so forth), and different data centers. The data centers are centralized locations where computing and networking equipment is concentrated to collect, store, process, distribute, or allow access to large amounts of data. A data center storage refers to devices, equipment, and software technologies that enable data and application storage within the data center storage. Depending on a scalability of the secondary storage and a size of the data center, there may be a need for more than one secondary storage cluster to protect one data center. Furthermore, the secondary storage may be used as a single point for accessing all metadata of the data center (for example, files and system scans), and for storing backup copies of systems and their metadata for allowing searches and reports based on collected data.

A ransomware attack is a type of malware that threatens to publish a victim's data or block access to the victim's data unless a ransom is paid. Some users use advanced techniques to encrypt the victim's data/files. Most existing physical and virtual machines (VMs) are attacked/contaminated by ransomware or other malware. When a virtual machine (VM) is contaminated, it is hard to detect a ransomware attack on the already contaminated virtual machine. Moreover, in the aforesaid data centers, the ransomware attack/contamination may target many virtual/physical machines in order to increase an impact on the availability of systems and data. Futhermore, it is difficult to stop the ransomware attack from spreading and contaminate more systems and hard to recover the data from those systems.

Known approaches mainly protect the data centers at a prevention level using firewalls, antivirus software, and so forth, and back up the physical/virtual machine on a regular basis. After a physical/virtual machine is already contaminated, there were manual steps that need to be done to isolate that specific physical/virtual machine from other physical/virtual machines and a responsible IT administrator may have to repeatedly check contamination of other physical/virtual machines (namely, one system after another). A disadvantage of known approaches is that they increases a period of time that elapses from the ransomware contamination or attack start until it is detected. This elapsed perod of time, namely time delay, in finding the ransomware contamination or attack allows a ransome threat to continue and spread through many more systems in a given enterprise.

Therefore, there arises a need to address the aforementioned technical problem/drawbacks in known approaches in detecting a ransomware attack over time on each system/machine/data source.

### SUMMARY

It is an object of the disclosure to provide an improve data processing arrangement that is coupled to a data memory arrangement and is configured to generate a file catalog including information describing characteristics of data files stored within the data memory arrangement for detecting a ransomware attack in a system/machine, and an improved method for operating the data processing arrangement coupled to the data memory arrangement to generate a file catalog including information describing characteristics of data files stored within the data memory arrangement for detecting the ransomware attack while avoiding one or more disadvantages of prior art approaches.

This object is achieved by the features of the independent claims. Furthermore, implementation forms are apparent from the dependent claims, the description, and the figures.

The disclosure provides a data processing arrangement that is coupled to a data memory arrangement and is configured to generate a file catalog including information describing characteristics of data files stored within the data memory arrangement for detecting a ransomware attack in a system/machine, and a method for operating the data processing arrangement coupled to the data memory arrangement to generate a file catalog including information describing characteristics of data files stored within the data memory arrangement for detecting the ransomware attack.

According to a first aspect, there is provided a data processing arrangement coupled to a data memory arrangement. The data processing arrangement is configured to generate a file catalog including information describing characteristics of data files stored within the data memory arrangement. The file catalog is periodically updated so that it provides a temporal record of the information. The data processing arrangement is configured to determine a behavioral profile indicative of temporal trends or patterns in the information, and to provide a warning indication in an event that the information for a given data file temporally changes in a manner that deviates more than a threshold amount from a model of expected temporal trends or patterns of the given data file.

The data processing arrangement enables comparison of the temporal trends or patterns of the given data file with fixed trends or patterns that are common in specific files, data blocks, and deduplication segments across an enterprise to detect a sudden change in the given data file. The data processing arrangement improves a detection time of a ransomware attack using an automatic detection policy that is activated based on any additional information collected by the data processing arrangement. Achieving a faster detection time for the data processing arrangement reduces a spread of ransomware to other systems in the enterprise. The data processing arrangement provides a warning indication/alert for any system malfunction in the enterprise in one central point of visibility, and this further shortens a response time by an information technology (IT) administrator. The data processing arrangement eliminates a necessity for the IT administrator to repeatedly check for contamination of each system/data source in the enterprise.

The data processing arrangement provides enterprise storage for all the data centers and provides a wide inclusive view of all the enterprise. The data processing arrangement provides a service of unstructured data management for the enterprise. The data processing arrangement provides a central viewpoint and a single management console for the enterprise storage. In addition, the data processing arrangement uses general and specific data collection in order to build a description of the behavior (namely, the behavioral profile) over time of each system/device in the enterprise.

The model of expected temporal trends or patterns may be determined from a manner in which the given data file has behaved previously in one or more of: the data processing arrangement, other data processing arrangements. The given data file may be an operating system file including executable program code or configuration data, or both.

Optionally, the data processing arrangement is configured to use a machine-learning arrangement including an adaptive neural network arrangement to determine the temporal trends or patterns, and to detect an occurrence of the temporal trends or patterns changing in a manner that deviates more than the threshold amount. The occurrence of the temporal trends or patterns changing in a manner that deviates more than the threshold amount may be an indicative of ransomware.

Optionally, the data processing arrangement is configured to provide a catalog service to a user of the data processing arrangement. The catalog service may provide an overview of the file catalog to the user. Optionally, the data processing arrangement is configured to use one or more artificial intelligence algorithms to analyse unstructured data obtained from the data files to generate the overview of the file catalog.

The information used to generate the file catalog may include one or more of: (i) temporal changes in data resource consumptions associated with the data files, (ii) temporal changes in data block segments of compressed or non-compressed data associated with the data files, (iii) temporal changes in randomization patterns associated with the data files, (iv) temporal changes in dispersal of volumes of the data files, and size changes associated therewith, (v) temporal changes in incremental file-system scans concerning sizes of the data files, and times at which the data files are accessed, (vi) temporal changes in sizes of the data files, (vii) temporal rates of change in characteristics of the data files, and (viii) temporal changes in input/output temperatures across the data files, as calculated from reads of the data files performed within a given time duration.

Optionally, the information used to generate the file catalog includes one or more of: (i) temporal changes in deduplication ratios of the data files, for a given system or a given group of systems, (ii) histories of scanning patterns of the data files, (iii) temporal changes in one or more of minimum, average and maximum sizes of the data files, (iv) temporal changes in central processing unit (CPU) power consumption, data memory arrangement power consumption, backup data for the data files, metadata for the data files, (v) temporal changes of randomization of the data files according to Bedford Law for detecting deviation or fraud, (vi) temporal changes in input-output dispersion rates in metadata related to block backup and backup-done segment-by-segment from a disc storage of the data memory arrangement to detect ranges of segments, and (vii) temporal input-output entropy changes in compressed or encrypted data indicative of ransomware compression (e.g. a rogue compression software) of the data files. Optionally, a file management system of the data processing arrangement is configured to scan the data files and is configured to log creation dates for the data files. The temporal changes may indicative of potential ransomware segmentation of the data files.

Optionally, the data processing arrangement is configured to dynamically adjust the threshold amount in response to a structure of one or more of: the data memory arrangement, the file catalog, a duration of during which the file catalog is being populated with data that characterized the data files.

According to a second aspect, there is provided a method for operating a data processing arrangement coupled to a data memory arrangement. The method includes configuring the data processing arrangement to generate a file catalog including information describing characteristics of data files stored within the data memory arrangement. The file catalog is periodically updated so that it provides a temporal record of the information. The method includes configuring the data processing arrangement to determine a behavioral profile indicative of temporal trends or patterns in the information, and to provide a warning indication in an event that the information for a given data file temporally changes in a manner that deviates more than a threshold amount from a model of expected temporal trends or patterns of the given data file.

The method enables comparison of the temporal trends or patterns of the given data file with fixed trends or patterns that are common in specific files, data blocks, and deduplication segments across an enterprise to detect a sudden change in the given data file. The method improves a detection time of a ransomware attack using an automatic detection policy that is activated based on any additional information collected by the data processing arrangement. The faster detection time reduces a spread of ransomware to other systems in the enterprise. The method provides a warning indication/alert for any system malfunction in the enterprise in one central point of visibility, and this further shortens the response time by an information technology (IT) administrator. The method eliminates a necessity of the IT administrator to repeatedly check for contamination of each system/data source in the enterprises.

The method provides a central viewpoint and a single management console for the enterprise storage. In addition, the data processing arrangement uses general and specific data collection in order to build a description of the behavior (namely, the behavioral profile) over time of each system/device in the enterprise.

Optionally, the method includes determining the model of expected temporal trends or patterns from a manner in which the given data file has behaved previously in one or more of: the data processing arrangement, other data processing arrangements. The given data file may be an operating system file including executable program code or configuration data, or both.

Optionally, the method includes configuring the data processing arrangement to use a machine-learning arrangement including an adaptive neural network arrangement to determine the temporal trends or patterns, and to detect an occurrence of the temporal trends or patterns changing in a manner that deviates more than the threshold amount.

Optionally, the method includes computing the occurrence of the temporal trends or patterns changing in a manner that deviates more than the threshold amount to be indicative of ransomware. Optionally, the method includes configuring the data processing arrangement to provide a catalog service to a user of the data processing arrangement. The catalog service may provide an overview of the file catalog to the user. Optionally, the method includes configuring the data processing arrangement to use one or more artificial intelligence algorithms to analyse unstructured data obtained from the data files to generate the overview of the file catalog.

Optionally, the method includes arranging for the information used to generate the file catalog to include one or more of: (i) temporal changes in data resource consumptions associated with the data files, (ii) temporal changes in data block segments of compressed or non-compressed data associated with the data files, (iii) temporal changes in randomization patterns associated with the data files, (iv) temporal changes in dispersal of volumes of the data files, and size changes associated therewith, (v) temporal changes in incremental file-system scans concerning sizes of the data files, and times at which the data files are accessed, (vi) temporal changes in sizes of the data files, (vii) temporal rates of change in characteristics of the data files, and (viii) temporal changes in input/output temperatures across the data files, as calculated from reads of the data files performed within a given time duration.

Optionally, the method includes arranging for the information used to generate the file catalog to include one or more of: (i) temporal changes in deduplication ratios of the data files, for a given system or a given group of systems, (ii) histories of scanning patterns of the data files, (iii) temporal changes in one or more of minimum, average and maximum sizes of the data files, (iv) temporal changes in central processing unit (CPU) power consumption, data memory arrangement power consumption, backup data for the data files, metadata for the data files, (v) temporal changes of randomization of the data files according to Bedford Law for detecting deviation or fraud, (vi) temporal changes in input-output dispersion rates in metadata related to block backup and backup-done segment-by-segment from a disc storage of the data memory arrangement to detect ranges of segments, and (vii) temporal input-output entropy changes in compressed or encrypted data indicative of ransomware compression (for example, a rogue compression software) of the data files. Optionally, a file management system of the data processing arrangement may be configured to scan the data files and is configured to log creation dates for the data files. The temporal changes may indicative of potential ransomware segmentation of the data files.

Optionally, the method includes configuring the data processing arrangement to dynamically adjust the threshold amount in response to a structure of one or more of: the data memory arrangement, the file catalog, a duration of during which the file catalog is being populated with data that characterized the data files.

According to a third aspect, there is provided a software product including computer-executable instructions. The instructions are executable on data processing hardware to implement the above method.

A technical problem in the prior art is resolved, where the technical problem is that the detection of a ransomware attack over time on each specific system/data source.

Therefore, in contradistinction to the prior art, according to the data processing arrangement and the method for operating the data processing arrangement coupled to the data memory arrangement to generate the file catalog including information describing characteristics of data files stored within the data memory arrangement to detect the ransomware, the comparison of the temporal trends or patterns of the given data file with fixed trends or patterns that are common in specific files, data blocks, and deduplication segments across an enterprise is enabled to detect a sudden change in the given data file. The data processing arrangement improves detection time of the ransomware attack using an automatic detection policy that is activated on any additional information collected by the data processing arrangement. The faster detection of the ransomware attack reduces the spread of ransomware to other systems in the enterprise.

These and other aspects of the disclosure will be apparent from and the implementation(s) described below.

### BRIEF DESCRIPTION OF THE DRAWINGS

Implementations of the disclosure will now be described, by way of example only, with reference to the accompanying drawings, in which:

FIG. 1 is a block diagram of a data processing arrangement coupled to a data memory arrangement to generate a file catalog in accordance with an implementation of the disclosure;

FIG. 2 is an exploded view of a data processing arrangement that provides a catalog service in accordance with an implementation of the disclosure;

FIG. 3 is an illustration of an exemplary view of a data processing arrangement that collects a file-system scan from a data center node (for example, a Windows OS system 32 device) in accordance with an implementation of the disclosure;

FIG. 4 is an illustration of an exemplary view of a data processing arrangement that stores a behavioral profile of a file-system scan from a data center node in accordance with an implementation of the disclosure;

FIG. 5 is a flow diagram that illustrates a method for operating a data processing arrangement coupled to a data memory arrangement to generate a file catalog for detecting a ransomware attack in accordance with an implementation of the disclosure; and

FIG. 6 is an illustration of an exemplary data processing arrangement or a computer system in which the various architectures and functionalities of the various previous implementations may be implemented.

### DETAILED DESCRIPTION

Implementations of the disclosure provide a data processing arrangement coupled to a data memory arrangement, wherein the data processing arrangement is configured to generate a file catalog including information describing characteristics of data files stored within the data memory arrangement to detect a ransomware attack. Moreover, the disclosure also relates to a method for operating the data processing arrangement coupled to the data memory arrangement to generate a file catalog.

To make solutions of the disclosure more comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

### Definitions

“Data memory arrangement”: this is a term referred to describe a data storage unit, or many grouped data storage units, that a network uses to store copies of data across high-speed connections. The data memory arrangement is flexible in that it allows the user to add additional storage when needed.

“Data Storage Unit”: such units are essential because they back up critical data files and other data to a central location. Users can then easily access these data files. The data storage units are data storage devices that allow storage and retrieval of data files from a central location for authorized network users.

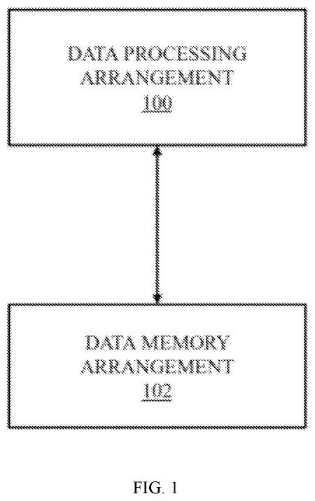

FIG. 1 is a block diagram of a data processing arrangement 100 coupled to a data memory arrangement 102 to generate a file catalog in accordance with an implementation of the disclosure. The data processing arrangement 100 is configured to generate a file catalog including information describing characteristics of data files stored within the data memory arrangement 102. The file catalog is periodically updated so that it provides a temporal record of the information. The data processing arrangement 100 is configured to determine a behavioral profile indicative of temporal trends or patterns in the information and to provide a warning indication in an event that the information for a given data file temporally changes in a manner that deviates more than a threshold amount from a model of expected temporal trends or patterns of the given data file.

The data processing arrangement 100 enables a comparison of the temporal trends or patterns of the given data file with fixed trends or patterns that are common in specific files, data blocks, and deduplication segments across an enterprise to detect a sudden change in the given data file. The data processing arrangement 100 improves a detection time of a ransomware attack using an automatic detection policy that is activated based on any additional information collected by the data processing arrangement 100. The faster detection time of the data processing arrangement 100 reduces a spread of ransomware to other systems in the enterprise. The data processing arrangement 100 provides a warning indication/alert for any system malfunction in the enterprise in one central point of visibility, and this further shortens a response time by an information technology (IT) administrator. The data processing arrangement 100 eliminates a necessity of the IT administrator to repeatedly check for contamination of each system/data source in the enterprises.

The data processing arrangement 100 provides enterprise storage for all the data centers. The data processing arrangement 100 provides a service of unstructured data management for the enterprise. The data processing arrangement 100 provides a central viewpoint and a single management console for the enterprise storage. In addition, the data processing arrangement 100 uses general and specific data collection in order to build a description of the behavior (namely, the behavioral profile) over time of each system/device in the enterprise. The data processing arrangement 100 may collect information on the unstructured data from all types of device/data sources (for example, network-assisted storage, NAS, S3, virtual machines, VMs, Environment, and so forth) in the enterprise storage.

Optionally, the data processing arrangement 100 tracks and records the temporal trends or patterns in the information provided by the data files as a function of time for each specific system/data source (for example, a NAS, a S3, a VMs Environment, data center nodes which including multiple devices) in the enterprise. Optionally, each specific system/data source is located in the data memory arrangement 102. Each system/data source and a tracked node (namely, a node in the data center) may have a behavioral profile depending on its character. The behavioral profile may describe the behavior over time of each system/data source or the data files from each system or data source for example, a device source). Optionally, the data processing arrangement 100 records the information describing characteristics of data files stored within the data memory arrangement 102 to generate the file catalog. The file catalog may be a storage assistance device. The file catalog is a central point for all systems in the enterprises and one or more sites. The file catalog may evaluate a deviation on behavioral trends or patterns. The file catalog may keep other object files and metadata as a part of the catalog. Optionally, the information used to generate the file catalog includes one or more of: (i) temporal changes in deduplication ratios of the data files, for a given system or a given group of systems, (ii) histories of scanning patterns of the data files, (iii) temporal changes in one or more of minimum, average and maximum sizes of the data files, (iv) temporal changes in central processing unit (CPU) power consumption, data memory arrangement power consumption, backup data for the data files, metadata for the data files, (v) temporal changes of randomization of the data files according to Bedford Law for detecting deviation or fraud, (vi) temporal changes in input-output dispersion rates in metadata related to block backup and backup-done segment-by-segment from a disc storage of the data memory arrangement 102 to detect ranges of segments and (vii) temporal input-output entropy changes in compressed or encrypted data indicative of ransomware compression of the data files. Optionally, a file management system of the data processing arrangement 100 is configured to scan the data files and is configured to log creation dates for the data files. The temporal changes may be indicative of potential ransomware segmentation of the data files. Optionally, the ransomware compression includes a rogue compression software.

Optionally, when each time the data processing arrangement 100 collects new data from existing systems/data sources, the data processing arrangement 100 compares all the sources of information as the recorded information (namely, new data collected) which is used to generate the file catalog to that of the behavioral profile. The behavioral profile may be stored in a database. Optionally, the data processing arrangement 100 provides a wide inclusive view of all the enterprises and checks for specific data files that are common to many systems/devices to detect if there is a sudden change in it. Optionally, the data processing arrangement 100 detects the sudden change or a strong deviation by comparing the specific data files to the behavioral profile in one or more of the systems at a predefined time interval. The data processing arrangement 100 may categorize the specific data files in a suspect list and may provide a warning indication/an alert to the IT Administrator.

Optionally, the data processing arrangement 100 is configured to use a machine-learning arrangement including an adaptive neural network arrangement to determine the temporal trends or patterns and to detect an occurrence of the temporal trends or patterns changing in a manner that deviates more than the threshold amount. The occurrence of the temporal trends or patterns changing in a manner that deviates more than the threshold amount may be indicative of ransomware.

Optionally, the data processing arrangement 100 is configured to dynamically adjust the threshold amount in response to a structure of one or more of: the data memory arrangement 102, the file catalog, a duration of during which the file catalog is being populated with data that characterized the data files.

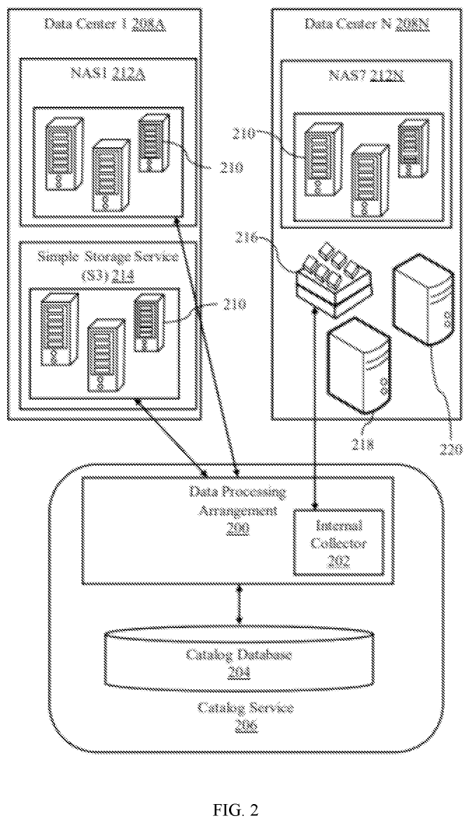

FIG. 2 is an exploded view of a data processing arrangement 200 that provides a catalog service 206 in accordance with an implementation of the disclosure. The exploded view includes the data processing arrangement 200 that includes an internal collector 202 and is communicatively connected to a catalog database (for example, ElasticSearch) 204. Optionally, the data processing arrangement 200 is configured to provide the catalog service 206 to a user of the data processing arrangement 200. The catalog service 206 provides an overview of the file catalog to the user. Optionally, the internal collector 202 collects information on the unstructured data from all types of system/data sources in an enterprise. The catalog service 206 may be a service of unstructured data management for the enterprise. Optionally, the catalog service 206 provides a full overview of all the file catalog to the user. Optionally, when each time the internal collector 202 of the data processing arrangement 200 collects new data from existing systems/data sources, the data processing arrangement 200 compares all the sources of information as the recorded information (namely, new data collected) which is used to generate the file catalog to that of the behavioral profile. The catalog database 204 may be any type of external database (for example, ElasticSearch database).

The device/data sources may be network attached storages, NAS, 212A-N, a simple storage service, S3, 214, a virtual machine, VM, Environment, a production ESX server 216, a Microsoft SQL Server (MSSQL) 218, a production Oracle 220, etc. The data centers 208A-N may include the network attached storages, NAS, 212A-N, the simple storage service, S3, 214, the virtual machine, VM, Environment, the production ESX server 216, the Microsoft SQL Server (MSSQL) 218, the production Oracle 220, and so forth. The NAS 212A-N are file-level computer data storage servers that are connected to a computer network for providing data access to a group of users/clients. The NAS 212A-N are optionally specialized for serving items/files either by its hardware, software, or configuration. The S3 214 is a web service that provides storage for the internet. The S3 214 is highly-scalable and secure in the cloud. Both the Microsoft SQL Server (MSSQL) 218 and the production Oracle 220 are widely used database or storage units by the enterprise.

Optionally, the system/data sources include a collector 210. The collector 210 may collect the information from the respective system/data sources. Optionally, the collection of information from all types of data/device sources may be performed periodically or in real-time, through the internal collector 202. The internal collector 202 may run in-host or outside of the system/data sources. The internal collector 202 may collect native metadata and additional synthetic data from the system/data sources. The data processing arrangement 200 may move the data files (for example, files or S3 objects) between tiers or internally (for example, from NAS1 212A to NAS2 212B in the same tier). The catalog service 206 may run different types of queries and perform analysis and supply insights on customer storage enterprise.

Optionally, the data processing arrangement 200 is configured to use one or more artificial intelligence algorithms to analyse unstructured data obtained from the data files to generate the overview of the file catalog.

Optionally, the information used to generate the file catalog includes one or more of: (i) temporal changes in data resource consumptions associated with the data files, (ii) temporal changes in data block segments of compressed or non-compressed data associated with the data files, (iii) temporal changes in randomization patterns associated with the data files, (iv) temporal changes in dispersal of volumes of the data files, and size changes associated therewith, (v) temporal changes in incremental file-system scans concerning sizes of the data files, and times at which the data files are accessed, (vi) temporal changes in sizes of the data files, (vii) temporal rates of change in characteristics of the data files, and (viii) temporal changes in input/output temperatures across the data files, as calculated from reads of the data files performed within a given time duration.

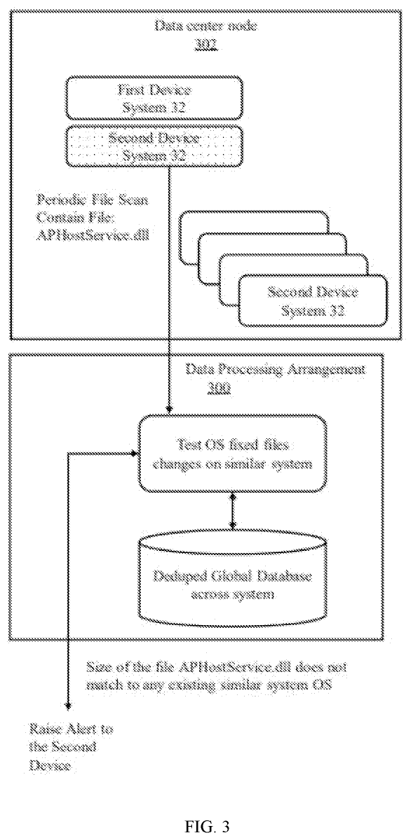

FIG. 3 is an illustration of an exemplary view of a data processing arrangement 300 that collects a file-system scan from a data center node 302 (for example, a Windows OS system 32 device) in accordance with an implementation of the disclosure. Optionally, the data processing arrangement 300 includes an internal collector and a database (for example, a deduped global database across the systems). The data center node 302 may include different types of system/devices (for example, a first device, a second device, and so forth). Each system/device may have a system 32. The system 32 is a folder in the Microsoft Windows operating system-based computers required for a computer to run properly. The system 32 is present in a drive-in which the Windows is installed. The system 32 directory includes Windows system files (namely, data files) and software program files, vital to the operation of the Windows operating system and software programs running in the Windows. The common types of files in the system 32 directory may be DLL (namely, Dynamic Link Library) and EXE (namely, executable) files.

Optionally, a model of expected temporal trends or patterns is determined from a manner in which the given data file (for example, Windows system files) has behaved previously in one or more of: the data processing arrangement 300, other data processing arrangements. The given data file may be an operating system file including executable program code or configuration data, or both.

Optionally, the data processing arrangement 300 collects a file-system scan from a Windows OS system 32 device (namely, from the second device) using the internal collector. The data processing arrangement 300 may detect a change in a file named ‘Aphostservice.dll’ from the file-system scan. The file (namely, ‘Aphostservice.dll’) may be a part of Accounts Host Service product developed by Microsoft and shall be the same in any Windows 10 exact release type (namely, Windows 10 have same files in the operating system as other computers).

Optionally, the data processing arrangement 300 detects, when it checks the data file (for example, ‘Aphostservice.dll’) against the database (for example, a deduped global database) across the systems, whether the data file has a change in size compared to its internal copy which is common to all other hosts with the same OS release. Optionally, the data processing arrangement 300 provides a warning indication/an alert to the second device, that the information for the data file (for example, ‘Aphostservice.dll’) temporally changes in a manner that deviates more than a threshold amount from an internal copy stored in the database across the systems (for example, the internal copy which is common to all other systems with the same OS release) for the data file.

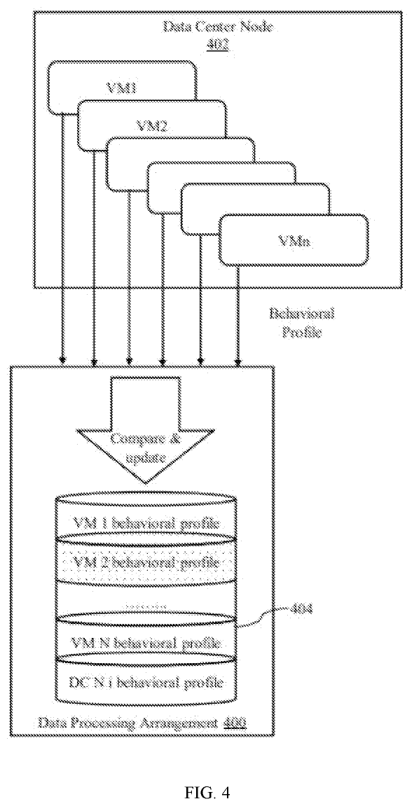

FIG. 4 is an illustration of an exemplary view of a data processing arrangement 400 that stores a behavioral profile 404 of a file-system scan from a data center node 402 in accordance with an implementation of the disclosure. The data center node 402 includes N-number of virtual machines (VM1-VMn). The data processing arrangement 400 may be configured to determine the behavioral profile 404 indicative of temporal trends or patterns in the information associated with the file-system scan. Optionally, the data processing arrangement 400 receives metadata periodically from the N-number of virtual machines. The behavioral profile 404 may include the metadata received from the N-number of virtual machines and stores the metadata about the N-number of virtual machines separately as a VM 1 behavioral profile, a VM 2 behavioral profile, and so forth. The metadata may include system scans, backups, and system resource monitoring, and so forth. The data processing arrangement 400 may compare all the metadata of the N-number of virtual machines (VM1-VMn) with the metadata that is stored in each matched behavioral profile (for example, a VM 1 behavioral profile, a VM 2 behavioral profile, and so forth) and constantly update the metadata of the N-number of virtual machines (VM1-VMn) to their respective behavioral profile. The exemplary view depicts a constant flow of the metadata (namely, the filesystem scans) from the virtual machines VM1-VMn into the data processing arrangement 400. Optionally, the data processing arrangement 400 compares each scan of the behavioral pattern to its existing recorded behavioral profile over time and detects if there is a deviation from its last scan. For example, the data processing arrangement 400 detects that (i) there is a significant jump in the percentage of change of the scan of VM2 compared to the usual/last scan for this virtual machine (namely, VM2), and (ii) there is a deviation in average file sizes that belongs to this scan, on the device VM2. The deviation in the average file sizes may be in both directions, smaller or bigger. The data processing arrangement 400 may trigger an alarm to that virtual machine (namely, the virtual machine VM2). The data processing arrangement 400 provides a central view to an entire enterprise and provides immediate visibility to an IT administrator in order to shorten the response time by an information technology (IT) administrator.

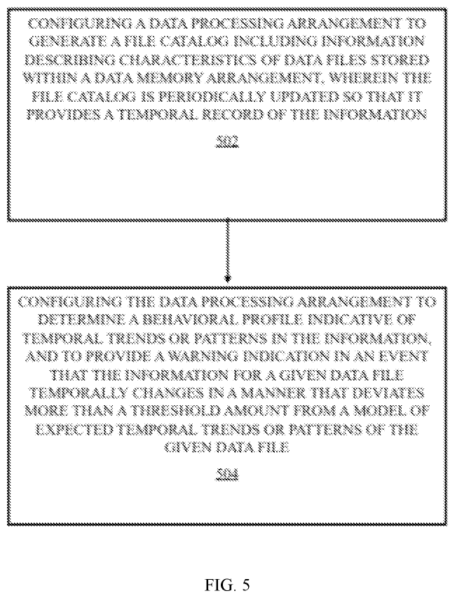

FIG. 5 is a flow diagram that illustrates a method for operating a data processing arrangement coupled to a data memory arrangement to generate a file catalog for detecting a ransomware attack in accordance with an implementation of the disclosure. At a step 502, the data processing arrangement is configured to generate a file catalog including information describing characteristics of data files stored within the data memory arrangement. The file catalog is periodically updated so that it provides a temporal record of the information. At a step 504, the data processing arrangement is configured to determine a behavioral profile indicative of temporal trends or patterns in the information, and to provide a warning indication in an event that the information for a given data file temporally changes in a manner that deviates more than a threshold amount from a model of expected temporal trends or patterns of the given data file.

The method enables a comparison of the temporal trends or patterns of the given data file with fixed trends or patterns that are common in specific files, data blocks, and deduplication segments across an enterprise to detect a sudden change in the given data file. The method improves detection time of a ransomware attack using an automatic detection policy that is activated based on any additional information collected by the data processing arrangement. The faster detection time reduces a spread of ransomware to other systems in the enterprise. The method provides a warning indication/alert for any system malfunction in the enterprise in one central point of visibility, and this further shortens a response time by an information technology (IT) administrator. The method eliminates necessity of the IT administrator to repeatedly check for contamination of each system/data source in the enterprises.

The method provides a central viewpoint and a single management console for the enterprise storage. In addition, the data processing arrangement uses general and specific data collection in order to build a description of the behavior (namely, the behavioral profile) over time of each system/device in the enterprise.

Optionally, the method includes determining the model of expected temporal trends or patterns from a manner in which the given data file has behaved previously in one or more of: the data processing arrangement, other data processing arrangements. The given data file may be an operating system file including executable program code or configuration data, or both.

Optionally, the method includes configuring the data processing arrangement to use a machine-learning arrangement including an adaptive neural network arrangement to determine the temporal trends or patterns and to detect an occurrence of the temporal trends or patterns changing in a manner that deviates more than the threshold amount. The method may include computing the occurrence of the temporal trends or patterns changing in a manner that deviates more than the threshold amount to be indicative of ransomware. Optionally, the method includes configuring the data processing arrangement to provide a catalog service to a user of the data processing arrangement. The catalog service may provide an overview of the file catalog to the user. The method may include configuring the data processing arrangement to use one or more artificial intelligence algorithms to analyse unstructured data obtained from the data files to generate the overview of the file catalog.

Optionally, the method includes arranging for the information used to generate the file catalog to include one or more of: (i) temporal changes in data resource consumptions associated with the data files, (ii) temporal changes in data block segments of compressed or non-compressed data associated with the data files, (iii) temporal changes in randomization patterns associated with the data files, (iv) temporal changes in dispersal of volumes of the data files, and size changes associated therewith, (v) temporal changes in incremental file-system scans concerning sizes of the data files, and times at which the data files are accessed, (vi) temporal changes in sizes of the data files, (vii) temporal rates of change in characteristics of the data files, and (viii) temporal changes in input/output temperatures across the data files, as calculated from reads of the data files performed within a given time duration.

Optionally, the method includes arranging for the information used to generate the file catalog to include one or more of: (i) temporal changes in deduplication ratios of the data files, for a given system or a given group of systems, (ii) histories of scanning patterns of the data files, (iii) temporal changes in one or more of minimum, average and maximum sizes of the data files, (iv) temporal changes in central processing unit (CPU) power consumption, data memory arrangement power consumption, backup data for the data files, metadata for the data files, (v) temporal changes of randomization of the data files according to Bedford Law for detecting deviation or fraud, (vi) temporal changes in input-output dispersion rates in metadata related to block backup and backup-done segment-by-segment from a disc storage of the data memory arrangement to detect ranges of segments, and (vii) temporal input-output entropy changes in compressed or encrypted data indicative of ransomware compression (e.g. a rogue compression software) of the data files. Optionally, a file management system of the data processing arrangement is configured to scan the data files and is configured to log creation dates for the data files. The temporal changes may be indicative of potential ransomware segmentation of the data files.

The method may include configuring the data processing arrangement to dynamically adjust the threshold amount in response to a structure of one or more of: the data memory arrangement, the file catalog, a duration of during which the file catalog is being populated with data that characterized the data files.

In an implementation, a software product including computer-executable instructions that are executable on data processing hardware to implement the above method.

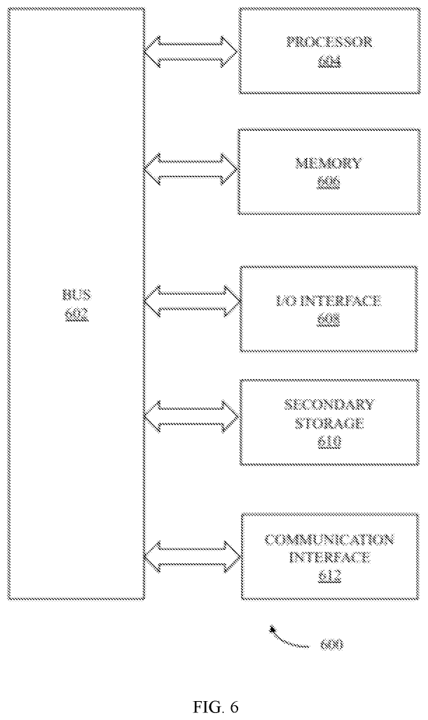

FIG. 6 is an illustration of an exemplary data processing arrangement or a computer system in which the various architectures and functionalities of the various previous implementations may be implemented. As shown, the computer system 600 includes at least one processor 604 that is connected to a bus 602, wherein the computer system 600 may be implemented using any suitable protocol, such as PCI (Peripheral Component Interconnect), PCI-Express, AGP (Accelerated Graphics Port), Hyper Transport, or any other bus or point-to-point communication protocol (s). The computer system 600 also includes a memory 606.

Control logic (software) and data are stored in the memory 606 which may take a form of random-access memory (RAM). In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 600 may also include a secondary storage 610. The secondary storage 610 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drives at least one of reads from and writes to a removable storage unit in a well-known manner.

Computer programs, or computer control logic algorithms, may be stored in at least one of the memory 606 and the secondary storage 610. Such computer programs, when executed, enable the computer system 600 to perform various functions as described in the foregoing. The memory 606, the secondary storage 610, and any other storage are possible examples of computer-readable media.

In an implementation, the architectures and functionalities depicted in the various previous figures may be implemented in the context of the processor 604, a graphics processor coupled to a communication interface 612, an integrated circuit (not shown) that is capable of at least a portion of the capabilities of both the processor 604 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 600 may take the form of a desktop computer, a laptop computer, a server, a workstation, a game console, an embedded system.

Furthermore, the computer system 600 may take the form of various other devices including, but not limited to a personal digital assistant (PDA) device, a mobile phone device, a smart phone, a television, and so forth. Additionally, although not shown, the computer system 600 may be coupled to a network (for example, a telecommunications network, a local area network (LAN), a wireless network, a wide area network (WAN) such as the Internet, a peer-to-peer network, a cable network, or the like) for communication purposes through an I/O interface 608.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

What is claimed is:

1. A data processing arrangement (100, 200, 300, 400) coupled to a data memory arrangement (102), wherein the data processing arrangement (100, 200, 300, 400) is configured to
generate a file catalog including information describing characteristics of data files stored within the data memory arrangement (102), wherein the file catalog is periodically updated so that it provides a temporal record of the information,
wherein the data processing arrangement (100, 200, 300, 400) is configured to determine a behavioral profile (404) indicative of temporal trends or patterns in the information, and to provide a warning indication in an event that the information for a given data file temporally changes in a manner that deviates more than a threshold amount from a model of expected temporal trends or patterns of the given data file.

2. The data processing arrangement (100, 200, 300, 400) of claim 1, wherein the model of expected temporal trends or patterns is determined from a manner in which the given data file has behaved previously in one or more of: the data processing arrangement (100, 200, 300, 400), other data processing arrangements.

3. The data processing arrangement (100, 200, 300, 400) of claim 2, wherein the given data file is an operating system file including executable program code or configuration data, or both.

4. The data processing arrangement (100, 200, 300, 400) of claim 1, wherein the data processing arrangement (100, 200, 300, 400) is configured to use a machine-learning arrangement including an adaptive neural network arrangement to determine the temporal trends or patterns, and to detect an occurrence of the temporal trends or patterns changing in a manner that deviates more than the threshold amount.

5. The data processing arrangement (100, 200, 300, 400) of claim 4, wherein the occurrence of the temporal trends or patterns changing in a manner that deviates more than the threshold amount is indicative of ransomware.

6. The data processing arrangement (100, 200, 300, 400) of claim 3, wherein the data processing arrangement (100, 200, 300, 400) is configured to provide a catalog service (206) to a user of the data processing arrangement (100, 200, 300, 400), wherein the catalog service (206) provides an overview of the file catalog to the user.

7. The data processing arrangement (100, 200, 300, 400) of claim 6, wherein the data processing arrangement (100, 200, 300, 400) is configured to use one or more artificial intelligence algorithms to analyse unstructured data obtained from the data files to generate the overview of the file catalog.

8. The data processing arrangement (100, 200, 300, 400) of claim 5, wherein the information used to generate the file catalog includes one or more of:
(i) temporal changes in data resource consumptions associated with the data files;
(ii) temporal changes in data block segments of compressed or non-compressed data associated with the data files;
(iii) temporal changes in randomization patterns associated with the data files;
(iv) temporal changes in dispersal of volumes of the data files, and size changes associated therewith;
(v) temporal changes in incremental file-system scans concerning sizes of the data files, and times at which the data files are accessed;
(vi) temporal changes in sizes of the data files;
(vii) temporal rates of change in characteristics of the data files; and
(viii) temporal changes in input/output temperatures across the data files, as calculated from reads of the data files performed within a given time duration.

9. The data processing arrangement (100, 200, 300, 400) of claim 5, wherein the information used to generate the file catalog includes one or more of:
(i) temporal changes in deduplication ratios of the data files, for a given system or a given group of systems;
(ii) histories of scanning patterns of the data files, wherein a file management system of the data processing arrangement (100, 200, 300, 400) is configured to scan the data files and is configured to log creation dates for the data files;
(iii) temporal changes in one or more of minimum, average and maximum sizes of the data files;
(iv) temporal changes in central processing unit (CPU) power consumption, data memory arrangement power consumption, backup data for the data files, metadata for the data files;
(v) temporal changes of randomization of the data files according to Bedford Law for detecting deviation or fraud;
(vi) temporal changes in input-output dispersion rates in metadata related to block backup and backup-done segment-by-segment from a disc storage of the data memory arrangement (102) to detect ranges of segments, wherein the temporal changes are indicative of potential ransomware segmentation of the data files; and
(vii) temporal input-output entropy changes in compressed or encrypted data indicative of ransomware compression of the data files.

10. The data processing arrangement (100, 200, 300, 400) of claim 1, wherein the data processing arrangement (100, 200, 300, 400) is configured to dynamically adjust the threshold amount in response to a structure of one or more of: the data memory arrangement (102), the file catalog, a duration of during which the file catalog is being populated with data that characterized the data files.

11. A method for operating a data processing arrangement (100, 200, 300, 400) coupled to a data memory arrangement (102), wherein the method includes:
configuring the data processing arrangement (100, 200, 300, 400) to generate a file catalog including information describing characteristics of data files stored within the data memory arrangement (102), wherein the file catalog is periodically updated so that it provides a temporal record of the information,
configuring the data processing arrangement (100, 200, 300, 400) to determine a behavioral profile (404) indicative of temporal trends or patterns in the information, and to provide a warning indication in an event that the information for a given data file temporally changes in a manner that deviates more than a threshold amount from a model of expected temporal trends or patterns of the given data file.

12. The method of claim 11, wherein the method includes determining the model of expected temporal trends or patterns from a manner in which the given data file has behaved previously in one or more of: the data processing arrangement (100, 200, 300, 400), other data processing arrangements.

13. The method of claim 12, wherein the given data file is an operating system file including executable program code or configuration data, or both.

14. The method of claim 11, wherein the method includes configuring the data processing arrangement (100, 200, 300, 400) to use a machine-learning arrangement including an adaptive neural network arrangement to determine the temporal trends or patterns, and to detect an occurrence of the temporal trends or patterns changing in a manner that deviates more than the threshold amount.

15. The method of claim 14, wherein the method includes computing the occurrence of the temporal trends or patterns changing in a manner that deviates more than the threshold amount to be indicative of ransomware.

16. The method of claim 13, wherein the method includes configuring the data processing arrangement (100, 200, 300, 400) to provide a catalog service (206) to a user of the data processing arrangement (100, 200, 300, 400), wherein the catalog service (206) provides an overview of the file catalog to the user.

17. The method of claim 16, wherein the method includes configuring the data processing arrangement (100, 200, 300, 400) to use one or more artificial intelligence algorithms to analyse unstructured data obtained from the data files to generate the overview of the file catalog.

18. The method of claim 15, wherein the method includes arranging for the information used to generate the file catalog to include one or more of:
(i) temporal changes in data resource consumptions associated with the data files;
(ii) temporal changes in data block segments of compressed or non-compressed data associated with the data files;
(iii) temporal changes in randomization patterns associated with the data files;
(iv) temporal changes in dispersal of volumes of the data files, and size changes associated therewith;
(v) temporal changes in incremental file-system scans concerning sizes of the data files, and times at which the data files are accessed;
(vi) temporal changes in sizes of the data files;
(vii) temporal rates of change in characteristics of the data files; and
(viii) temporal changes in input/output temperatures across the data files, as calculated from reads of the data files performed within a given time duration.

19. The method of claim 15, wherein the method includes arranging for the information used to generate the file catalog to include one or more of:
(i) temporal changes in deduplication ratios of the data files, for a given system or a given group of systems;
(ii) histories of scanning patterns of the data files, wherein a file management system of the data processing arrangement (100, 200, 300, 400) is configured to scan the data files and is configured to log creation dates for the data files;
(iii) temporal changes in one or more of minimum, average and maximum sizes of the data files;
(iv) temporal changes in central processing unit (CPU) power consumption, data memory arrangement power consumption, backup data for the data files, metadata for the data files;
(v) temporal changes of randomization of the data files according to Bedford Law for detecting deviation or fraud;
(vi) temporal changes in input-output dispersion rates in metadata related to block backup and backup-done segment-by-segment from a disc storage of the data memory arrangement (102) to detect ranges of segments, wherein the temporal changes are indicative of potential ransomware segmentation of the data files; and
(vii) temporal input-output entropy changes in compressed or encrypted data indicative of ransomware compression of the data files.

20. The method of claim 11, wherein the method includes configuring the data processing arrangement (100, 200, 300, 400) to dynamically adjust the threshold amount in response to a structure of one or more of: the data memory arrangement (102), the file catalog, a duration of during which the file catalog is being populated with data that characterized the data files.
